(19) United States
(12) Patent Application Publication
(10) Pub. No.: US 2025/0263342 A1
(43) Pub. Date: Aug. 21, 2025

(54) Gypsum Panel Containing an Intercalated Additive

(71) Applicant: Gold Bond Building Products, LLC, Charlotte, NC (US)

(72) Inventors: Xing Yang, Charlotte, NC (US); Ratnasabapathy Gurunathan Iyer, Charlotte, NC (US)

(21) Appl. No.: 19/051,287

(22) Filed: Feb. 12, 2025

Related U.S. Application Data
(60) Provisional application No. 63/553,736, filed on Feb. 15, 2024.

(51) Int. Cl. C04B 28/14; B28B 19/00; C04B 14/18; C04B 14/20; C04B 20/02; C04B 22/02; C04B 103/63; C04B 111/00; C04B 111/28

(52) U.S. Cl. CPC C04B 28/14; B28B 19/0092; C04B 14/18; C04B 14/202; C04B 20/026; C04B 22/02; C04B 2103/63; C04B 2111/0062; C04B 2111/285

(57) ABSTRACT

The present invention is directed to gypsum panels containing an intercalated additive and a method of making such gypsum panels. In one embodiment, the gypsum panel comprises a gypsum core, a first facing material, and a second facing material. The gypsum panel comprises a fire resistance composition including an intercalated additive.

### RELATED APPLICATIONS

The present application is based upon and claims priority to U.S. Provisional Patent Application Ser. No. 63/553,736, having a filing date of Feb. 15, 2024, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. The mixture is cast and allowed to set by reaction of the calcined gypsum with the water. During the production process, a variety of additives can be incorporated into the gypsum panel to enhance the physical and mechanical properties of the gypsum panel.

In general, various additives have been utilized to enhance the fire resistance properties of gypsum panels when the gypsum panels are exposed to high temperatures, such as those generated by a fire. Notably, the inclusion of various additives may reduce or prevent board shrinkage and maintain board integration. However, it remains to be ascertained which compositions are particularly suitable for imparting fire resistance characteristics and properties.

As a result, a need exists for providing a gypsum panel with improved fire resistance properties. In particular, a need exists for providing a gypsum panel with enhanced fire resistance properties when exposed to high temperatures.

### SUMMARY OF THE INVENTION

Aspects and advantages of the invention will be set forth in part in the following description, or may be obvious from the description, or may be learned through practice of the invention.

In accordance with one embodiment of the present invention, a gypsum panel is disclosed. The gypsum panel may include: a gypsum core comprising gypsum; a fire resistance composition comprising an intercalated additive, the intercalated additive comprising an intumescent material and one or more intercalated compounds and/or ions, the intercalated additive being present in the gypsum panel in an amount from about 0.0001 wt. % to about 5 wt. %; and a first facing material and a second facing material sandwiching the gypsum core.

The one or more intercalated compounds and/or ions may include one or more sulfates. The one or more intercalated compounds and/or ions may include one or more carbonates, one or more bicarbonates, or a combination thereof.

Notably, the intumescent material may be expandable graphite, vermiculite, or a combination thereof.

The intercalated additive may be formed by a process including milling a mixture comprising the intumescent material and one or more intercalating agents. The intercalated additive may be formed by a process including mixing an aqueous solution comprising the intumescent material and one or more intercalating agents.

In accordance with another embodiment of the present invention, a gypsum panel is disclosed. The gypsum panel may include: a gypsum core comprising gypsum; a fire resistance composition comprising an intercalated additive, the intercalated additive comprising an intumescent material and one or more intercalated compounds and/or ions, wherein the intercalated additive is a multi-intercalated additive; and a first facing material and a second facing material sandwiching the gypsum core.

The intercalated additive may be present in the gypsum panel in an amount from about 0.0001 wt. % to about 5 wt. %.

The one or more intercalated compounds and/or ions may include one or more sulfates. The one or more intercalated compounds and/or ions may include one or more carbonates, one or more bicarbonates, or a combination thereof.

Notably, the intumescent material may be expandable graphite, vermiculite, or a combination thereof.

The intercalated additive may be formed by a process including milling a mixture comprising the intumescent material and one or more intercalating agents. The intercalated additive may be formed by a process including mixing an aqueous solution comprising the intumescent material and one or more intercalating agents.

The intercalated additive may be formed by the intercalation of two or more types of intercalated compounds and/or ions into the intumescent material sequentially, wherein a first intercalated compound and/or ion is intercalated into the intumescent material and a second intercalated compound and/or ion is intercalated into the intumescent material, the second intercalated compound and/or ion being intercalated into the intumescent material after the first intercalated compound and/or ion.

In accordance with a further embodiment of the present invention, a method of making a gypsum panel is disclosed. The method comprises: providing a first facing material; depositing a gypsum slurry comprising stucco and water onto the first facing material; providing a second facing material on the gypsum slurry; and allowing the stucco to convert to calcium sulfate dihydrate. The gypsum panel may include a fire resistance composition including an intercalated additive. The intercalated additive may include an intumescent material and one or more intercalated compounds and/or ions, the fire resistance composition being present in the gypsum panel in an amount from about 0.0001 wt. % to about 5 wt. %.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core, one or more fire resistance compositions, and one or more facing materials. In this regard, the gypsum core can include gypsum (i.e., calcium sulfate dihydrate), one or more fire resistance compositions, and may include other optional additives. The present inventors have discovered that the gypsum panel disclosed herein can have various benefits due to the use of a fire resistance composition, particularly a fire resistance composition containing one or more intercalated additives. For instance, the gypsum panel disclosed herein may have enhanced expansion and/or fire suppression properties when compared to traditional fire-resistant gypsum panels.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. It should be understood that any concentration values disclosed herein may refer to mass concentration, molar concentration, number concentration, or volume concentration. It should be understood that, unless stated otherwise, any standard listed herein (e.g., ASTM) is the most recent version available as of the latest revision year. Notably, some aspects of the present disclosure may omit one or more of the features disclosed herein.

Notably, a gypsum panel formed in accordance with the present disclosure may possess improved shrinkage characteristics. The shrinkage of a gypsum panel may be measured via a thermomechanical analyzer (TMA). The test may be conducted using the ASTM E119-16a ramp rates with a sample size of 5-10 mm by 5-10 mm by 0.5-26 mm (11 mm thickness), including all increments of 1 mm therebetween. For instance, in one aspect, the test may be conducted using the ASTM E119-16a ramp rates with a sample size of 5 mm by 5 mm by 12.7 mm (12.7 mm thickness). In another aspect, the test may be conducted using the ASTM E119-16a ramp rates with a sample size of 5 mm by 5 mm by 15.875 mm (15.875 mm thickness). Using TMA, a change in dimension, in particular thickness can be determined and as measured herein, the shrinkage and thickness are based on the values at 950° C. Without the fire resistance composition as disclosed herein, a gypsum panel may have an average shrinkage of greater than 20%. However, by employing a fire resistance composition as disclosed herein, the gypsum panel may exhibit a shrinkage of 20% or less, such as 16% or less, such as 15% or less, such as 14% or less, such as 12% or less, such as 10% or less, such as 8% or less, such as 6% or less, such as 5% or less. The gypsum panel may have an average shrinkage of greater than 0%, such as 0.5% or more, such as 1% or more, such as 2% or more, such as 3% or more, such as 5% or more, such as 10% or more. Such percentages are based on the initial thickness.

As another means for determining the effect of the fire resistance composition on gypsum, the shrinkage can be measured by determining an area shrinkage (i.e., of a face instead of a thickness). For such area shrinkage, it can be determined utilizing a board sample or a cast gypsum bar, such as one having dimensions of 1″×1″×11.25″ (face or back of 1″×11.25″ and a thickness of 1″), drying the bar at 45° C. until a constant mass is obtained, and conditioning the bar at 70° F. and 50% RH for 12 hours. After conditioning, the bars or board samples are placed into a muffle furnace and quickly ramped according to ramp rates as defined in ASTM E119-16a to a temperature of about 950° C. The percentage change in shrinkage is determined by comparing the area after heating with the initial 1″×11.25″ or board sample area.

Notably, in some aspects, a gypsum core and/or any gypsum core layers thereof formed in accordance with the present disclosure may exhibit expansion when exposed to high temperatures and/or fire. In general, a gypsum core and/or any gypsum core layers thereof incorporating a fire resistance composition as disclosed herein may exhibit a maximum expansion from about 30% to about 0%, including all increments of 0.01% therebetween, when exposed to high temperatures and/or fire. For instance, a gypsum core and/or any gypsum core layers thereof comprising a fire resistance composition as disclosed herein may exhibit a maximum expansion when exposed to high temperatures and/or fire of about 30% or less, such as about 25% or less, such as about 20% or less, such as about 16% or less, such as about 15% or less, such as about 14% or less, such as about 12% or less, such as about 10% or less, such as about 8% or less, such as about 6% or less, such as about 5% or less. In general, a gypsum core and/or any gypsum core layers thereof comprising a fire resistance composition as disclosed herein may exhibit a maximum expansion when exposed to high temperatures and/or fire of about 0% or more, such as about 0.5% or more, such as about 1% or more, such as about 2% or more, such as about 3% or more, such as about 5% or more, such as about 10% or more, such as about 15% or more, such as about 20% or more. It should be understood that the maximum expansion of a gypsum core and/or gypsum core layer may determined using the maximum thickness obtained when the gypsum core and/or gypsum core layer is exposed to high temperatures and/or a fire, by the maximum area obtained when the gypsum core and/or gypsum core layer is exposed to high temperatures and/or a fire, or by the maximum volume obtained when the gypsum core and/or gypsum core layer is exposed to high temperatures and/or a fire. Generally, a gypsum core and/or gypsum core layer that is exposed to high temperatures and/or a fire expands while being heated. It should be understood that the maximum expansion is determined while the gypsum core and/or gypsum core layer is being heated and measures the maximum expansion achieved by the gypsum core and/or gypsum core layer.

Notably, in some aspects, a gypsum core and/or any gypsum core layers thereof comprising the fire resistance composition may have less shrinkage than a traditional gypsum core and/or any gypsum core layers thereof that do not contain the fire resistance composition.

In some embodiments, an assembly may be constructed using gypsum panels of the present disclosure wherein the assembly may conform to the specification of Underwriters Laboratories, Inc. (UL®) assemblies, such as U419, U305, and U423. For a fire test, the face of one side of the assembly can be exposed to increasing temperatures for a period of time in accordance with a heating curve, such as those discussed in ASTM E119-16a. The temperatures proximate the heated side and the temperatures at the surface of the unheated side of the assembly are monitored during the tests to evaluate the temperatures experienced by the exposed gypsum panels and the heat transmitted through the assembly to the unexposed panels.

In this regard, in one embodiment, an assembly of gypsum panels formed according to the present disclosure and in accordance with the specification of a U419 assembly, with or without cavity insulation, may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less, such as about 60 minutes or less, such as about 59.5 minutes or less, such as about 59 minutes or less, such as about 58.5 minutes or less, such as about 58 minutes or less, such as about 57.5 minutes or less, such as about 57 minutes or less, such as about 56.5 minutes or less, such as about 56 minutes or less, such as about 55.5 minutes or less, such as about 55 minutes or less, such as about 52.5 minutes or less when heated in accordance with the time-temperature curve of ASTM standard E119-16a.

In one embodiment, an assembly of gypsum panels formed according to the present disclosure and in accordance with the specification of a U305 assembly may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less, such as about 60 minutes or less, such as about 59.5 minutes or less, such as about 59 minutes or less, such as about 58.5 minutes or less, such as about 58 minutes or less, such as about 57.5 minutes or less, such as about 57 minutes or less, such as about 56.5 minutes or less, such as about 56 minutes or less, such as about 55.5 minutes or less, such as about 55 minutes or less, such as about 52.5 minutes or less when heated in accordance with the time-temperature curve of ASTM standard E119-16a.

In one embodiment, an assembly of gypsum panels formed according to the present disclosure and in accordance with the specification of a U423 assembly may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less, such as about 60 minutes or less, such as about 59.5 minutes or less, such as about 59 minutes or less, such as about 58.5 minutes or less, such as about 58 minutes or less, such as about 57.5 minutes or less, such as about 57 minutes or less, such as about 56.5 minutes or less, such as about 56 minutes or less, such as about 55.5 minutes or less, such as about 55 minutes or less, such as about 52.5 minutes or less when heated in accordance with the time-temperature curve of ASTM standard E119-16a.

In general, the gypsum core may comprise calcium sulfate dihydrate. The gypsum used to make the gypsum core may be from a natural source, a synthetic source, and/or from reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

Generally, a gypsum panel formed in accordance with the present disclosure may have one or more fire resistance compositions applied (e.g., sprayed) to and/or incorporated in any component of a gypsum panel (e.g., a gypsum core, a gypsum core layer, a facing material, a gypsum slurry) at any time of the process disclosed herein, including during, before, and/or after any of the process steps disclosed herein. Notably, one or more fire resistance compositions may be incorporated in one or more gypsum slurries (e.g., a first gypsum slurry, a second gypsum slurry, a third gypsum slurry) and/or one or more gypsum core layers (e.g., a first gypsum core layer, a second gypsum core layer, a third gypsum core layer). Generally, a fire resistance composition and/or any of the components thereof may be present between the first facing material and the gypsum slurry and/or gypsum core and/or may be present between the second facing material and the gypsum slurry and/or gypsum core. In general, a fire resistance composition may be applied by spraying, brushing, curtain coating, and/or roll coating.

Notably, a fire resistance composition applied to and/or incorporated in any component of a gypsum panel may be the same as or different than a fire resistance composition applied to and/or incorporated in a different component of a gypsum panel. For instance, a fire resistance composition incorporated in a first gypsum core layer may be the same as or different than a fire resistance composition incorporated in a third gypsum core layer.

In one aspect, a fire resistance composition may be incorporated in and/or applied to one or more facing materials (e.g., first facing material, second facing material). Generally, the method of application of the fire resistance composition is not limited by the present disclosure and may include any method of application known in the art. Notably, the fire resistance composition may be incorporated in and/or applied to the first facing material, the gypsum slurry, the second facing material, or a combination thereof. In one aspect, a fire resistance composition may be incorporated in and/or applied to at least a portion of a surface of a first facing material and/or at least a portion of a surface of a second facing material that is adjacent to the gypsum slurry and/or gypsum core (i.e., the gypsum slurry and/or gypsum core facing surface of the first facing material, the gypsum slurry and/or gypsum core facing surface of the second facing material) before the gypsum slurry is deposited, provided, or contacted with the first facing material and/or before the second facing material is provided on or contacted with the gypsum slurry respectively. In another aspect, a fire resistance composition may be incorporated in and/or applied to the gypsum slurry before the second facing material is provided on or contacted with the gypsum slurry. In this respect, the fire resistance composition may be incorporated in and/or applied to at least a portion of the gypsum slurry adjacent the second facing material before the second facing material is provided on or contacted with the gypsum slurry. Additionally, in yet another aspect, the fire resistance composition may be incorporated in and/or applied to the gypsum slurry before the second facing material is provided on or contacted with the gypsum slurry and may be incorporated in and/or applied to at least a portion of the surface of the second facing material that is adjacent the gypsum slurry (i.e., the gypsum slurry facing surface of the second facing material) before the second facing material is provided on or contacted with the gypsum slurry.

As previously disclosed herein, the fire resistance composition may be applied to one or more facing materials on a surface or side of a facing material (e.g., first facing material, second facing material) adjacent to a gypsum slurry and/or gypsum core. In general, the fire resistance composition may be applied to one or more facing materials on a surface or side of a facing material (e.g., first facing material, second facing material) opposite a gypsum slurry and/or gypsum core. In this respect, the fire resistance composition may be applied to one or more facing materials on the outward facing surface of one or more facing materials.

In general, the fire resistance composition may be incorporated in and/or applied to one or more facing materials (e.g., first facing material, second facing material) during the manufacturing process of the gypsum panel and/or in an offline process. When incorporated and/or applied in an offline process, the fire resistance composition may be applied to a facing material (e.g., first facing material, second facing material) before the facing material is utilized in the manufacturing process of the gypsum panel.

Notably, a gypsum panel formed in accordance with the present disclosure may include a fire resistance composition comprising one or more intercalated additives. In general, an intercalated additive may comprise one or more intumescent materials and one or more intercalated compounds and/or ions. In this respect, an intercalated additive may comprise one or more intumescent materials having been intercalated by one or more compounds and/or ions. Notably, the one or more compounds and/or ions may originate or come from one or more intercalating agents.

In general, a fire resistance composition disclosed herein may comprise one or more intercalated additives, such as two intercalated additives or three intercalated additives. The intercalated additives may be selectively chosen to form a combination of intercalated additives that synergistically interact to enhance the expansion properties of a gypsum panel. Further, a gypsum panel formed in accordance with the present disclosure may comprise more than one of the same intercalated additive, except that the respective intercalated additives have different properties (e.g., average particle size, particle size distribution).

Generally, an intercalated additive may be formed from the combination or mixing of one or more components. In some aspects, the intercalated additive may be formed by milling a mixture of one or more intumescent materials, one or more intercalating agents, one or more grinding agents, stucco, gypsum, a liquid (e.g., water), or a combination thereof. In some aspects, the intercalated additive may be formed via solvent exchange by forming a mixture of one or more intumescent materials, one or more intercalating agents, and/or water.

As previously disclosed herein, an intercalated additive may include one or more intumescent materials. In general, the one or more intumescent materials may include, for instance, graphite (e.g., expandable graphite), perlite, vermiculite, or a combination thereof. As used herein, when expandable graphite, perlite, or vermiculite are intercalated, they may be referred to as intercalated expandable graphite, intercalated perlite, or intercalated vermiculite respectively. As previously disclosed herein, an intercalated additive may be formed by utilizing one or more intercalating agents. The one or more intercalating agents may include, for instance, sulfuric acid, nitric acid, phosphoric acid, perchloric acid, chromic acid, hydrochloric acid, acetic acid, one or more carbonate compounds (e.g., one or more metal carbonates), one or more bicarbonate compounds (e.g., one or more metal bicarbonates), one or more borate compounds (e.g., one or more metal borates), one or more nitrate compounds (e.g., one or more metal nitrates), one or more sulfate compounds (e.g., one or more metal sulfates), one or more halide compounds (e.g., one or more metal halides), one or more hydroxide compounds (e.g., one or more metal hydroxides), one or more phosphate compounds, urea, thiourea, melamine, or a combination thereof. In general, ammonium may be a component of one or more of the aforementioned compounds. Notably, the one or more sulfate compounds may include ammonium sulfate. Notably, the one or more phosphate compounds may include ammonium phosphate, such as monoammonium phosphate and/or diammonium phosphate. Notably, the one or more carbonate compounds may include sodium carbonate.

In some aspects, an intercalated additive in accordance with the present disclosure may include mica and/or talc. Notably, the mica and/or talc may be intercalated with any of the intercalating agents disclosed herein via any of the methods disclosed herein.

In general, one or more intercalating agents may include ammonium, one or more alkali metals (e.g., lithium, sodium, potassium), one or more alkaline earth metals (e.g., magnesium, calcium), one or more transition metals (e.g., aluminum, copper, nickel), or a combination thereof. The one or more alkali metals, one or alkaline earth metals, and/or one or more transition metals may be a component of one or more of the aforementioned compounds that include a metal (e.g., a metal carbonate, a metal bicarbonate, a metal borate, a metal nitrate, a metal sulfate, a metal halide, a metal hydroxide).

As previously disclosed herein, one or more intercalated additives may comprise one or more intercalated compounds and/or ions. It should be understood that the one or more intercalated compounds and/or ions may originate or come from one or more intercalating agents, such as any of the intercalating agents disclosed herein. Notably, in some aspects, an intercalated additive may comprise two or more types of intercalated compounds and/or ions. As used herein, a “multi-intercalated additive” refers to an intercalated additive that comprises two or more types of intercalated compounds and/or ions. In general, an intercalated additive may include two or more types of intercalated compounds and/or ions, such as one or more metals, one or more carbonates, one or more bicarbonates, one or more borates, one or more nitrates, one or more sulfates, one or more phosphates, one or more halides, one or more acids, one or more hydroxides, urea, thiourea, melamine, or a combination thereof. It should be understood that the previous listing includes compounds incorporating one or more carbonates, one or more bicarbonates, one or more borates, one or more nitrates, one or more sulfates, one or more phosphates, one or more halides, one or more acids, one or more hydroxides, urea, thiourea, melamine, or a combination thereof, and any respective ions thereof (e.g., sulfate ions, nitrate ions).

Notably, one or more intercalated compounds and/or ions may be present in an intercalated additive in an amount from about 0.0001 wt. % to about 10 wt. %, including all increments of 0.0001 wt. % therebetween, based on the weight of the intercalated additive. In one aspect, the aforementioned values may be based on the weight of the intumescent material of the intercalated additive.

Generally, one or more intercalated compounds and/or ions may be present in an intercalated additive in an amount of about 0.0001 wt. % or more, such as about 0.001 wt. % or more, such as about 0.01 wt. % or more, such as about 0.1 wt. % or more, such as about 1 wt. % or more, such as about 2 wt. % or more, such as about 3 wt. % or more, such as about 4 wt. % or more, such as about 5 wt. % or more based on the weight of the intercalated additive. The one or more intercalated compounds and/or ions may be present in an intercalated additive in an amount of about 10 wt. % or less, such as about 8 wt. % or less, such as about 5 wt. % or less, such as about 4 wt. % or less, such as about 2 wt. % or less, such as about 2 wt. % or less, such as about 1 wt. % or less, such as about 0.1 wt. % or less, such as about 0.01 wt. % or less. In one aspect, the aforementioned values may be based on the weight of the intumescent material of the intercalated additive.

The utilization of an intercalated additive or a multi-intercalated additive may be particularly useful in fire-resistant gypsum panels. For instance, an intercalated additive or a multi-intercalated additive may be intercalated with one or more compounds and/or ions that inhibit gas phase chemical reactions, enhance char formation, and/or enhance expansion properties. With respect to inhibiting gas phase chemical reactions, the intercalated compounds and/or ions may release gases that dilute the oxygen concentration around and/or in the gypsum panel. With respect to enhancing char formation, the intercalated compounds and/or ions may form chemicals that are involved in pyrolysis or carbonization reactions that result in char formation. With respect to enhancing expansion properties, the intercalated compounds and/or ions may affect the distance between the layers of an intumescent material, which may affect the expansion properties of the fire resistance composition and/or gypsum panel. Further, and more generally, the intercalated compounds and/or ions may affect the expansion properties of the fire resistance composition and/or gypsum panel over various temperature ranges depending on the particular intercalated compounds and/or ions utilized in the intercalated additive. In this respect, different intercalated compounds and/or ions may activate, or in other words, provide their respective fire resistance effect(s), over different temperature ranges.

Notably, two or more intercalated compounds and/or ions may be intercalated into an intumescent material sequentially and/or simultaneously to form a multi-intercalated additive. In one aspect, two or more intercalated compounds and/or ions may be intercalated into an intumescent material sequentially. For instance, in one aspect, a first intercalated compound and/or ion may be intercalated into an intumescent material via milling and/or solvent exchange. Then, a second intercalated compound and/or ion may be intercalated into the intumescent material via milling and/or solvent exchange after the intercalation of the first intercalated compound and/or ion. In one aspect, two or more types of intercalated compounds and/or ions may be intercalated into an intumescent material simultaneously. For instance, a first intercalated compound and/or ion and a second intercalated compound and/or ion may be intercalated into an intumescent material simultaneously via milling or solvent exchange. In one aspect, two or more intercalated compounds and/or ions may be intercalated into an intumescent material sequentially and simultaneously. For instance, a first intercalated compound and/or ion may be intercalated into an intumescent material via milling and/or solvent exchange. Then, a second intercalated compound and/or ion and a third intercalated compound and/or ion may be intercalated into the intumescent material via milling and/or solvent exchange after the intercalation of the first intercalated compound and/or ion.

In general, an intercalated additive may be formed by the milling (e.g., ball-milling) of various components at any time of the process disclosed herein, including during, before, and/or after any of the process steps disclosed herein. Generally, the intimate contact between one or more intumescent materials and one or more intercalating agents during milling or grinding may result in the formation of an intercalated additive and/or a multi-intercalated additive. Notably, an intercalated additive may be formed by milling a mixture comprising one or more intumescent materials, one or more intercalating agents, one or more grinding agents, stucco, gypsum, a liquid (e.g., water), or a combination thereof. In some aspects, one or more intumescent materials, one or more intercalating agents, one or more grinding agents, stucco, gypsum, and/or a liquid (e.g., water) may be milled together, such as by dry milling or wet milling. As used herein, “milled” is synonymous with “ground”. Notably, the milling of the mixture may decrease the average particle size of the one or more intumescent materials, one or more intercalating agents, one or more grinding agents, stucco, and/or gypsum. Additionally, the milling of the mixture may decrease the average particle size of an intercalated additive formed by the milling of the mixture. It should be understood that any of the components of the fire resistance composition may be milled together or may be milled separately. When milled separately, the components of the fire resistance composition may be combined or mixed before being applied to and/or incorporated in any component of a gypsum panel. The milling of a fire resistance composition and/or any components (e.g., an intercalated additive) thereof may be particularly advantageous. In this respect, the application and/or incorporation of a milled fire resistance composition and/or the application and/or incorporation of a fire resistance composition comprising milled components may improve the expansion properties, such as controlled expansion, of a gypsum panel as compared to a gypsum panel that contains a fire resistance composition that is not milled and/or contains components that are not milled. It should be understood that the fire resistance composition itself may be milled at any time of the process disclosed herein, including during, before, and/or after any of the process steps disclosed herein.

As previously disclosed, an intercalated additive may be formed via ball-milling. However, it should be understood that an intercalated additive may be formed via milling by other equipment such as, for instance, an attritor, a vibration mill, an impact mill, a planetary ball mill, a jet mill, and the like.

Generally, in one aspect, a fire resistance composition may comprise one or more grinding agents. The one or more grinding agents may assist in decreasing the particle size of a fire resistance composition and/or any components thereof (e.g., intercalated additive). In one aspect, one or more grinding agents may be milled together with one or more intercalating agents, one or more intumescent materials, stucco, and/or gypsum to form one or more intercalated additives and may assist in decreasing the particle size of the one or more formed intercalated additives. In one aspect, one or more grinding agents may include dextrose, a sulfonate (e.g., a lignosulfonate, a naphthalene sulfonate), a carboxylate (e.g., a polycarboxylate ester), boric acid, sodium trimetaphosphate, a starch, gypsum, stucco, or a combination thereof.

In general, a fire resistance composition may comprise a liquid (e.g., one or more surfactants, one or more dispersants, one or more siloxanes, one or more retarders, one or more alcohols, acetone, and/or water). Additionally, in one aspect, the fire resistance composition may include an accelerator, such as one or more of the accelerators described in U.S. Pat. No. 9,878,950, which is incorporated herein by reference in its entirety. In one aspect, the fire resistance composition and/or the gypsum core may be free or substantially free of vermiculite, perlite, and/or expanded graphite. As used herein, “substantially free” means that the vermiculite, perlite, and/or expanded graphite content of the fire resistance composition and/or the gypsum core is less than about 0.01 wt. %, such as about 0.005 wt. % or less.

Generally, the milling of a fire resistance composition and/or any components thereof may decrease the average particle size of the fire resistance composition and/or any components thereof. In one aspect, a fire resistance composition may comprise gypsum that has a smaller average particle size than the gypsum of the gypsum core. Notably, a decrease in the average particle size of an intercalated additive may enhance the expansion properties of a gypsum panel. In this respect, a decrease in the average particle size of an intercalated additive may enhance the uniformity of expansion of a gypsum core and/or gypsum panel when exposed to high temperatures. Additionally, milling or grinding may also aid in controlling the expansion of the intercalated additive such that expansion during exposure to heat allows the board to expand without destroying board integrity.

In general, an aqueous solution may be made in the process of forming an intercalated additive, including during, before, and/or after any of the process steps disclosed herein. In one aspect, an aqueous solution may be prepared by combining one or more intumescent materials, one or more intercalating agents, one or more grinding agents, stucco, gypsum, and/or a liquid. The aqueous solution may then be milled or ground itself and/or with one or more intumescent materials, one or more intercalating agents one or more grinding agents, stucco, gypsum, or a combination thereof. In this respect, an aqueous solution may be milled or ground itself and/or may be combined with one or more intumescent materials, one or more intercalating agents one or more grinding agents, stucco, gypsum, or a combination thereof and then milled or ground.

Generally, an intercalated additive may be formed via solvent exchange involving various components at any time of the process disclosed herein, including during, before, and/or after any of the process steps disclosed herein. In general, forming an intercalated additive via solvent exchange may include preparing an aqueous solution including water and one or more intercalating agents. The concentration of the one or more intercalating agents in the solution may be from about 0.01% to about 99%, including all increments of 0.01% therebetween. For instance, the concentration of the one or more intercalating agents in the solution may be about 0.01% or more, such as about 0.02% or more, such as about 0.03% or more, such as about 0.04% or more, such as about 0.05% or more, such as about 0.1% or more, such as about 1% or more, such as about 5% or more, such as about 10% or more, such as about 20% or more, such as about 40% or more, such as about 60% or more, such as about 80% or more. In general, the concentration of the one or more intercalating agents in the solution may be about 99% or less, such as about 80% or less, such as about 60% or less, such as about 40% or less, such as about 20% or less, such as about 10% or less, such as about 5% or less, such as about 1% or less, such as about 0.05% or less.

After one or more intercalating agents are added to the solution, one or more intumescent materials may be added to the solution. In general, one or more intumescent materials may be added to the solution such that the concentration of the intumescent material in the solution is from about 0.01% to about 99%, including all increments of 0.01% therebetween. For instance, the concentration of the one or more intumescent materials in the solution may be about 0.01% or more, such as about 0.02% or more, such as about 0.03% or more, such as about 0.04% or more, such as about 0.05% or more, such as about 0.1% or more, such as about 1% or more, such as about 5% or more, such as about 10% or more, such as about 20% or more, such as about 40% or more, such as about 60% or more, such as about 80% or more. In general, the concentration of the one or more intumescent materials in the solution may be about 99% or less, such as about 80% or less, such as about 60% or less, such as about 40% or less, such as about 20% or less, such as about 10% or less, such as about 5% or less, such as about 1% or less, such as about 0.05% or less. Notably, an intumescent material may be in the form of particles and/or flakes when added to the solution.

Next, the solution of the one or more intercalating agents and the one or more intumescent materials may be mixed or agitated to form one or more intercalated additives and/or multi-intercalated additives. The one or more intercalating agents and the one or more intumescent materials may be mixed for a period of about 5 seconds to about 2 hours, including all increments of 1 second therebetween. For instance, the one or more intercalating agents and the one or more intumescent materials may be mixed for a period of about 5 seconds or more, such as about 30 seconds or more, such as about 1 minute or more, such as about 2 minutes or more, such as about 5 minutes or more, such as about 10 minutes or more, such as about 30 minutes or more, such as about 1 hour or more. In general, the one or more intercalating agents and the one or more intumescent materials may be mixed for a period of about 2 hours or less, such as about 1 hour or less, such as about 30 minutes or less, such as about 10 minutes or less, such as about 5 minutes or less, such as about 2 minutes or less, such as about 1 minute or less. After the mixing of the solution, the one or more formed intercalated additives may be filtered out of the solution and incorporated in a fire resistance composition. In another aspect, the solution may be incorporated in a fire resistance composition without filtering out the one or more formed intercalated additives.

Notably, the one or more intercalated additives may be dried and/or milled after being mixed in the solution. For instance, the one or more intercalated additives may be dried at a temperature from about 30° C. to about 150° C., including all increments of 1° C. therebetween. In this respect, in some aspects, one or more intercalated additives may be dried at a temperature of about 30° C. or more, such as about 40° C. or more, such as about 50° C. or more, such as about 60° C. or more, such as about 80° C. or more, such as about 100° C. or more. In general, one or more intercalated additives may be dried at a temperature of about 150° C. or less, such as about 120° C. or less, such as about 100° C. or less, such as about 80° C. or less, such as about 60° C. or less, such as about 50° C. or less, such as about 40° C. or less. The one or more intercalated additives may be incorporated into a fire resistance composition after being dried.

Generally, a fire resistance composition and/or any components (e.g., an intercalated additive) thereof may be in the form of a solid (e.g., powder, fines, granules), a liquid, or a mixture thereof. In general, a fire resistance composition and/or any component thereof may be applied to and/or incorporated in any component of a gypsum panel in the form of a solid, a liquid (e.g., a solution), or a mixture (e.g., a dispersion) thereof. As used herein, the term “dispersion” refers to a liquid having solid particles dispersed therein. In one aspect, the liquid of a dispersion may be water and the solid particles of the dispersion may be one or more intercalated additives and/or one or more grinding agents. In general, the fire resistance composition may be applied and/or incorporated as a dry application, a wet application, or a combination thereof. As used herein, a “dry application” of a fire resistance composition refers to the application and/or incorporation of a fire resistance composition that does not comprise a liquid. As used herein, a “wet application” of a fire resistance composition refers to the application and/or incorporation of a fire resistance composition that comprises a liquid.

Generally, a fire resistance composition and/or any components thereof may undergo mixing in a shear mixer, such as a Quadro® Liquids high shear mixer, pin mixer, or an Axiflow@ high shear mixer, at any time of the process disclosed herein, including during, before, and/or after any of the process steps disclosed herein. In general, a shear mixer may combine a liquid (e.g., one or more surfactants, one or more dispersants, one or more siloxanes, one or more retarders, one or more alcohols, and/or water) with a fire resistance composition and/or any components (e.g., an intercalated additive) thereof. In one aspect, the combination of a liquid and a fire resistance composition and/or any components thereof in a shear mixer may form a dispersion. In this respect, in one aspect, the fire resistance composition and/or any components thereof may form the solid portion of a dispersion. In some aspects, a fire resistance composition and/or any components thereof may be mixed or combined prior to being mixed in a shear mixer. In this respect, in one aspect, a fire resistance composition and/or any components thereof may undergo one or more mixing processes. Notably, a shear mixer may continuously mix a liquid with a fire resistance composition and/or any components thereof. After the shear mixer has mixed a liquid with a fire resistance composition and/or any components thereof, the resulting fire resistance composition, which may be in the form of a dispersion, may be applied (e.g., sprayed) to and/or incorporated in a facing material and/or a gypsum slurry.

In one aspect, a surface of a facing material (e.g., first facing material, second facing material) adjacent to a gypsum slurry and/or gypsum core may include a fire resistance composition and/or any components (e.g., an intercalated additive) thereof applied to and/or present on at least a portion of the surface of the facing material adjacent to a gypsum slurry and/or gypsum core. For instance, a fire resistance composition and/or any components (e.g., an intercalated additive) thereof may be applied to and/or be present on the surface of a facing material adjacent to a gypsum slurry and/or gypsum core in an amount of about 1% or more of the surface area of the surface of the facing material, such as in an amount of about 1% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

In one aspect, a surface of a facing material (e.g., first facing material, second facing material) opposite a gypsum slurry and/or gypsum core may include a fire resistance composition and/or any components (e.g., an intercalated additive) thereof applied to and/or present on at least a portion of the surface of the facing material opposite a gypsum slurry and/or gypsum core. For instance, a fire resistance composition and/or any components (e.g., an intercalated additive) thereof may be applied to and/or be present on the surface of a facing material opposite a gypsum slurry and/or gypsum core in an amount of about 1% or more of the surface area of the surface of the facing material, such as in an amount of about 1% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

In one aspect, the application of a fire resistance composition may result in the penetration and/or embedment of a fire resistance composition and/or any components (e.g., an intercalated additive) thereof in one or more of the facing materials (e.g., first facing material, second facing material). Notably, the penetration and/or embedment of a fire resistance composition and/or any components (e.g., an intercalated additive) thereof may result in improved fire resistance characteristics and properties. Generally, if the fire resistance composition is applied via spraying, the intensity and/or angle of the spraying and the distance of the spraying mechanism to the facing material may affect the depth of penetration of the fire resistance composition and/or any components (e.g., an intercalated additive) thereof.

Generally, a fire resistance composition and/or any components thereof may penetrate at least a portion of the thickness of a respective facing material (e.g., first facing material, second facing material). Notably, the fire resistance composition and/or any components (e.g., an intercalated additive) thereof may penetrate a respective facing material (e.g., first facing material, second facing material) by about 0% to about 100% of the thickness of the respective facing material, such as about 0% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less.

Generally, when a fire resistance composition is applied to a facing material, the longer the fire resistance composition and/or any components thereof (e.g., an intercalated additive) is in fluid contact with a facing material, the deeper the penetration of the fire resistance composition and/or any components thereof. Notably, a fire resistance composition and/or any components thereof may be in fluid contact with a facing material for a period of about 1 second to about 30 seconds, including all increments of 1 second therebetween. For instance, a fire resistance composition and/or any components thereof may be in fluid contact with a facing material for about 1 second or more, such as about 5 seconds or more, such as about 10 seconds or more, such as about 15 seconds or more, such as about 20 seconds or more, such as about 25 seconds or more, such as about 30 seconds or less, such as about 25 seconds or less, such as about 20 seconds or less, such as about 15 seconds or less, such as about 10 seconds or less, such as about 5 seconds or less. In this respect, a fire resistance composition and/or any components thereof may be in fluid contact with a facing material for a period of about 1 second to about 30 seconds, including all increments of 1 second therebetween, until a gypsum slurry contacts or is provided on a respective facing material.

In general, a fire resistance composition and/or an intercalated additive may be applied to and/or present in the gypsum panel in an amount of 0.001 lbs/MSF to about 125 lbs/MSF, including all increments of 0.001 lbs/MSF therebetween. For instance, a fire resistance composition and/or an intercalated additive may be applied to and/or present in the gypsum panel in an amount of 0.001 lbs/MSF or more, such as 0.01 lbs/MSF or more, such as 0.05 lbs/MSF or more, such as 0.1 lb/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 10 lbs/MSF or more, such as 50 lbs/MSF or more, such as 100 lbs/MSF or more. Generally, a fire resistance composition and/or an intercalated additive may be applied to and/or present in the gypsum panel in an amount of 125 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

Further, a fire resistance composition and/or an intercalated additive may be applied to and/or present in the gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more, such as 5 wt. % or more, such as 8 wt. % or more. Generally, a fire resistance composition and/or an intercalated additive may be applied to and/or present in a gypsum panel and/or any component thereof in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.30 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As previously disclosed, a fire resistance composition may comprise one or more intercalated additives. For instance, one or more intercalated additives may be present in a fire resistance composition in an amount from about 0.01 wt. % to about 100 wt. %, including all increments of 0.01 wt. % therebetween. In this respect, one or more intercalated additives may be present in a fire resistance composition in an amount of about 0.01 wt. % or more, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 60 wt. % or more, such as about 70 wt. % or more, such as about 80 wt. % or more, such as about 90 wt. % or more, such as about 100 wt. % or less, such as about 90 wt. % or less, such as about 80 wt. % or less, such as about 70 wt. % or less, such as about 60 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less, such as about 5 wt. % or less, such as about 1 wt. % or less.

Notably, in one aspect, the weight ratio of intercalated expandable graphite to intercalated vermiculite in a fire resistance composition may be from about 1:100 to about 100:1, including all incremental ratios therebetween. For instance, the weight ratio of intercalated expandable graphite to intercalated vermiculite in a fire resistance composition may be about 1:100 or more, such as about 1:99 or more, such as about 10:90 or more, such as about 20:80 or more, such as about 30:70 or more, such as about 40:60 or more, such as about 50:50 or more, such as about 60:40 or more, such as about 70:30 or more, such as about 80:20 or more, such as about 90:10 or less, such as about 80:20 or less, such as about 70:30 or less, such as about 60:40 or less, such as about 50:50 or less, such as about 40:60 or less, such as about 30:70 or less, such as about 20:80 or less, such as about 10:90 or less.

In one aspect, intercalated expandable graphite and vermiculite may be present in a fire resistance composition in a weight ratio from about 1:100 to about 100:1, including all incremental ratios therebetween. For instance, the weight ratio of intercalated expandable graphite to vermiculite in a fire resistance composition may be about 1:100 or more, such as about 1:99 or more, such as about 10:90 or more, such as about 20:80 or more, such as about 30:70 or more, such as about 40:60 or more, such as about 50:50 or more, such as about 60:40 or more, such as about 70:30 or more, such as about 80:20 or more, such as about 90:10 or less, such as about 80:20 or less, such as about 70:30 or less, such as about 60:40 or less, such as about 50:50 or less, such as about 40:60 or less, such as about 30:70 or less, such as about 20:80 or less, such as about 10:90 or less.

Generally, a fire resistance composition may comprise gypsum and/or stucco. For instance, gypsum and/or stucco may be present in a fire resistance composition in an amount from about 0.01 wt. % to about 99.99 wt. %, including all increments of 0.01 wt. % therebetween. In this respect, gypsum and/or stucco may be present in a fire resistance composition in an amount of about 0.01 wt. % or more, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 60 wt. % or more, such as about 70 wt. % or more, such as about 80 wt. % or more, such as about 90 wt. % or more, such as about 99.99 wt. % or less, such as about 90 wt. % or less, such as about 80 wt. % or less, such as about 70 wt. % or less, such as about 60 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less, such as about 5 wt. % or less, such as about 1 wt. % or less.

In general, a fire resistance composition may include gypsum and an intercalated additive (e.g., intercalated expandable graphite) in a weight ratio from about 99:1 to about 1:99, including all incremental ratios therebetween. For instance, a fire resistance composition may include gypsum and an intercalated additive in a weight ratio of about 99:1 or less, such as about 80:1 or less, such as about 60:1 or less, such as about 40:1 or less, such as about 20:1 or less, such as about 1:1 or less, such as about 1:20 or less, such as about 1:40 or less, such as about 1:60 or less, such as about 1:80 or less, such as about 1:99 or more, such as about 1:80 or more, such as about 1:60 or more, such as about 1:40 or more, such as about 1:20 or more, such as about 1:1 or more, such as about 20:1 or more, such as about 40:1 or more, such as about 60:1 or more, such as about 80:1 or more.

As previously disclosed herein, one or more grinding agents may be included in a fire resistance composition. For instance, one or more grinding agents may be present in a fire resistance composition in an amount from about 0 wt. % to about 60 wt. %, including all increments of 0.01 wt. % therebetween. In one aspect, a fire resistance composition may comprise one or more grinding agents in an amount of about 0 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 4.5 wt. % or more, such as about 5 wt. % or more, such as about 5.5 wt. % or more, such as about 6 wt. % or more, such as about 6.5 wt. % or more, such as about 7 wt. % or more, such as about 8 wt. % or more, such as about 9 wt. % or more, such as about 10 wt. % or more, such as about 11 wt. % or more, such as about 12 wt. % or more, such as about 13 wt. % or more, such as about 14 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more based on the weight of the fire resistance composition. In general, a fire resistance composition may comprise one or more grinding agents in an amount of about 60 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 14 wt. % or less, such as about 13 wt. % or less, such as about 12 wt. % or less, such as about 11 wt. % or less, such as about 10 wt. % or less, such as about 9 wt. % or less, such as about 8 wt. % or less, such as about 7.5 wt. % or less, such as about 7 wt. % or less, such as about 6.5 wt. % or less, such as about 6 wt. % or less, such as about 5.5 wt. % or less, such as about 5 wt. % or less, such as about 4.5 wt. % or less, such as about 4 wt. % or less, such as about 3.5 wt. % or less, such as about 3 wt. % or less, such as about 2.5 wt. % or less, such as about 2 wt. % or less, such as about 1.5 wt. % or less, such as about 1 wt. % or less based on the weight of the fire resistance composition.

As previously disclosed, a fire resistance composition may comprise a liquid (e.g., one or more surfactants, one or more dispersants, one or more siloxanes, one or more retarders, one or more alcohols, and/or water). For instance, a liquid may be present in a fire resistance composition in an amount from about 0 wt. % to about 99.99 wt. %, including all increments of 0.01 wt. % therebetween. In this respect, a liquid (e.g., one or more surfactants, one or more dispersants, one or more siloxanes, one or more retarders, one or more alcohols, and/or water) may be present in a fire resistance composition in an amount of about 0 wt. % or more, such as about 10 wt. % or more, such as about 20 wt. % or more, such as about 30 wt. % or more, such as about 40 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 99.99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 40 wt. % or less, such as about 30 wt. % or less, such as about 20 wt. % or less, such as about 10 wt. % or less based on the weight of the fire resistance composition. Particularly, in one aspect, when a fire resistance composition is applied via a wet application, a liquid may be present in a fire resistance composition in an amount from about 50 wt. % to about 99.99 wt. %, including all increments of 0.01 wt. % therebetween.

In order to provide the desired effect, the fire resistance composition and/or any component (e.g., an intercalated additive) thereof may have a particular average particle size. For instance, the fire resistance composition and/or any component (e.g., an intercalated additive) thereof may have an average particle size of 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 80 microns or less, such as 75 microns or less, such as 50 microns or less, such as 40 microns or less, such as 25 microns or less, such as 20 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The fire resistance composition and/or any component (e.g., an intercalated additive) thereof may have an average particle size of 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 25 microns or more, such as 40 microns or more, such as 50 microns or more, such as 75 microns or more, such as 80 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more. Furthermore, in one aspect, the aforementioned values may refer to a median particle size of the fire resistance composition and/or any components thereof. In this respect, the fire resistance composition and/or any components thereof may have a D₁₀, D₅₀, D₉₀, and/or D₉₇ of any of the values previously disclosed, including any incremental values therebetween. Notably, a fire resistance composition and/or any component (e.g., an intercalated additive) thereof may be ground or milled to have a median particle size and/or average particle size from 5 nanometers to 3 mm, including all increments of 1 nanometer therebetween. Notably, in one aspect, the aforementioned values may refer to the agglomerate size of the fire resistance composition and/or any components thereof. In one aspect, the aforementioned values may refer to the agglomerate size and the particle size of the fire resistance composition and/or any components thereof. In this respect, the aforementioned values may refer to the combined average and/or combined median size of the agglomerates (i.e., particle agglomerates) and the individual particles of the fire resistance composition and/or any components thereof. For instance, if a fire resistance composition contains 30 wt. % agglomerates and 70 wt. % individual particles, all of the sizes of the agglomerates and the individual particles may be analyzed to determine an average and/or median of the combined agglomerates and individual particles.

Generally, the fire resistance composition and/or any components thereof may have a particular particle size distribution. The particle size distribution of the fire resistance composition and/or any components thereof (e.g., an intercalated additive) may be monomodal, bi-modal, or multi-modal.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In some aspects, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry is not necessarily limited and may be any generally known in the art. Generally, in one embodiment, the gypsum core is made from a gypsum slurry including at least stucco, water, and a fire resistance composition.

In general, stucco may be referred to as calcined gypsum or calcium sulfate hemihydrate. The calcined gypsum may be from a natural source, a synthetic source, and/or reclaim and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., All, Alll), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry, gypsum core, and/or fire resistance composition may include a dispersant. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry, gypsum core, and/or fire resistance composition may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In one aspect, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glyercol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

Notably, the gypsum slurry, gypsum core, and/or fire resistance composition may include a starch. The starch may be one generally utilized in the art. Such starch may be combined with the stucco and water. In this regard, such starch may be present in the gypsum slurry as well as the resulting gypsum core and gypsum panel. In one aspect, one or more components of a gypsum panel may be free of starch. For instance, the gypsum core and/or gypsum slurry may be free of starch. In one aspect, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, gypsum, liquid, fire resistance composition) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer or pinless mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a crystalline matrix of calcium sulfate dihydrate. In this respect, the stucco may convert into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

Notably, as previously disclosed herein, a fire resistance composition and/or any components thereof may be milled at any time of the process disclosed herein, including during, before, and/or after any of the process steps disclosed herein.

In one embodiment, the gypsum core may include a first gypsum core layer and a second gypsum core layer. The first gypsum core layer may be between the first facing material (e.g., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (e.g., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

The gypsum panel disclosed herein may have many applications. For instance, the gypsum panel may be used as a standalone panel in construction for the preparation of walls, ceilings, floors, roofs, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g, including all increments of 0.01 m²/g therebetween. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lbr_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

Fire resistance compositions were formed in accordance with the present disclosure. Each fire resistance composition was a composition comprising expandable graphite or intercalated expandable graphite. Each fire resistance composition Sample weighed one gram and a graduated cylinder was used to measure the initial volume of the Sample and the final volume of the Sample. Table 1 illustrates the percent expansion of the respective Samples containing expandable graphite or an intercalated expandable graphite. Sample 1 contained expandable graphite. One gram of Sample 1 was collected and placed in a crucible. The graduated cylinder containing Sample 1 was dropped from a height of 1″ onto a bench top five consecutive times in immediate succession. The initial volume of Sample 1 was then measured. Next, Sample 1 was placed in a crucible and exposed to a temperature of 450° C. in an oven for ten minutes, allowed to cool to ambient temperature, and then measured for its expansion via the graduated cylinder.

Sample 2 was an intercalated expandable graphite fire resistance composition formed from mixing 2 grams of the expandable graphite of Sample 1 with 18 grams of sodium carbonate aqueous solution having a 20% concentration for 6 minutes. The composition was then filtered through Whatman Grade 42 Ashless Filter Paper. Then, the composition was dried to constant weight at 45° C. and then broken down with mortar and pestle. Then, one gram of Sample 2 was collected and placed in a crucible and exposed to a temperature of 450° C. in an oven for ten minutes, allowed to cool to ambient temperature, and then measured for its expansion.

Notably, Samples 3-8 were individually hand-mixed, dried to constant weight at 45° C., and broken down with mortar and pestle. Then one gram of each Sample was collected and placed in a crucible and exposed to a temperature of 450° C. in an oven for ten minutes, allowed to cool to ambient temperature, and then measured for its respective expansion. Sample 3 was an expandable graphite fire resistance composition formed from mixing 2 grams of the expandable graphite of Sample 1 with 4.6 grams of water for 1 minute. Sample 4 was an intercalated expandable graphite fire resistance composition formed from mixing 0.68 grams of the expandable graphite of Sample 1 with 0.32 grams of diammonium phosphate for 1 minute. Sample 5 was an intercalated expandable graphite fire resistance composition formed from mixing 0.68 grams of the expandable graphite of Sample 1 with 0.32 grams of monoammonium phosphate for 1 minute. Sample 6 was an intercalated expandable graphite fire resistance composition formed from mixing 2 grams of the expandable graphite of Sample 1 with 4.6 grams of diammonium phosphate aqueous solution having a 20% concentration for 1 minute. Sample 7 was an intercalated expandable graphite fire resistance composition formed from mixing 2 grams of the expandable graphite of Sample 1 with 4.6 grams of monoammonium phosphate aqueous solution having a 20% concentration for 1 minute. Sample 8 was an intercalated expandable graphite fire resistance composition formed from mixing 2 grams of the expandable graphite of Sample 1 with 4.6 grams of urea aqueous solution having a 20% concentration for 1 minute.

TABLE 1

| | Original | Post-450° C. | Percent |
|---|---|---|---|
| | Volume | Volume | Expansion |
| Sample Number | [mL] | [mL] | [%] |
| 1 | 3.2 | 19.1 | 597 |
| 2 | 2.9 | 19.0 | 664 |
| 3 | 3.2 | 18.5 | 577 |
| 4 | 2.5 | 12.2 | 488 |
| 5 | 2.4 | 12.0 | 500 |
| 6 | 3.3 | 23.4 | 716 |
| 7 | 2.4 | 20.0 | 833 |
| 8 | 2.3 | 20.0 | 870 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core, the gypsum core comprising gypsum;
a fire resistance composition, the fire resistance composition comprising an intercalated additive, the intercalated additive comprising an intumescent material and one or more intercalated compounds and/or ions, the intercalated additive being present in the gypsum panel in an amount from about 0.0001 wt. % to about 5 wt. %; and
a first facing material and a second facing material sandwiching the gypsum core.

2. The gypsum panel of claim 1, wherein the one or more intercalated compounds and/or ions comprise one or more sulfates.

3. The gypsum panel of claim 1, wherein the one or more intercalated compounds and/or ions comprise one or more carbonates, one or more bicarbonates, or a combination thereof.

4. The gypsum panel of claim 1, wherein the intumescent material is expandable graphite.

5. The gypsum panel of claim 1, wherein the intumescent material is vermiculite.

6. The gypsum panel of claim 1, wherein the intercalated additive is formed by a process including milling a mixture comprising the intumescent material and one or more intercalating agents.

7. The gypsum panel of claim 1, wherein the intercalated additive is formed by a process including mixing an aqueous solution comprising the intumescent material and one or more intercalating agents.

8. A gypsum panel comprising:
a gypsum core, the gypsum core comprising gypsum;
a fire resistance composition, the fire resistance composition comprising an intercalated additive, the intercalated additive comprising an intumescent material and one or more intercalated compounds and/or ions, wherein the intercalated additive is a multi-intercalated additive; and
a first facing material and a second facing material sandwiching the gypsum core.

9. The gypsum panel of claim 8, wherein the intercalated additive is present in the gypsum panel in an amount from about 0.0001 wt. % to about 5 wt. %.

10. The gypsum panel of claim 8, wherein the one or more intercalated compounds and/or ions comprise one or more sulfates.

11. The gypsum panel of claim 8, wherein the one or more intercalated compounds and/or ions comprise one or more carbonates, one or more bicarbonates, or a combination thereof.

12. The gypsum panel of claim 8, wherein the intumescent material is expandable graphite.

13. The gypsum panel of claim 8, wherein the intumescent material is perlite.

14. The gypsum panel of claim 8, wherein the intumescent material is vermiculite.

15. The gypsum panel of claim 8, wherein the intercalated additive is formed by a process including milling a mixture comprising the intumescent material and one or more intercalating agents.

16. The gypsum panel of claim 8, wherein the intercalated additive is formed by a process including mixing an aqueous solution comprising the intumescent material and one or more intercalating agents.

17. The gypsum panel of claim 8, wherein the intercalated additive is formed by the intercalation of two or more types of intercalated compounds and/or ions into the intumescent material sequentially, wherein a first intercalated compound and/or ion is intercalated into the intumescent material and a second intercalated compound and/or ion is intercalated into the intumescent material, the second intercalated compound and/or ion being intercalated into the intumescent material after the first intercalated compound and/or ion.

18. A method for making a gypsum panel comprising:
providing a first facing material;
depositing a gypsum slurry comprising stucco and water onto the first facing material;
providing a second facing material on the gypsum slurry; and
allowing the stucco to convert to calcium sulfate dihydrate;
wherein the gypsum panel comprises a fire resistance composition, the fire resistance composition comprising an intercalated additive, the intercalated additive comprising an intumescent material and one or more intercalated compounds and/or ions, the fire resistance composition being present in the gypsum panel in an amount from about 0.0001 wt. % to about 5 wt. %.

19. The method of claim 18, wherein the intumescent material is expandable graphite.

20. The method of claim 19, wherein the intercalated additive is a multi-intercalated additive.
